(19) United States
(12) Patent Application Publication
(10) Pub. No.: US 2026/0328158 A1
(43) Pub. Date: Oct. 22, 2026

(54) PISTON CROWN WITH CHANNELS AND METHOD

(71) Applicant: Transportation IP Holdings, LLC, Norwalk, CT (US)

(72) Inventors: Harland Ashby, Norwalk, CT (US); Manuel Flores, Norwalk, CT (US); Adam Klingbeil, Norwalk, CT (US); Peter Bocchini, Norwalk, CT (US); Brett Heher, Norwalk, CT (US)

(73) Assignee: Transportation IP Holdings, LLC, Norwalk, CT (US)

(21) Appl. No.: 19/186,045

(22) Filed: Apr. 22, 2025

(51) Int. Cl. F02F 3/22; F01P 3/10

(52) U.S. Cl. CPC F02F 3/22; F01P 3/10

(57) ABSTRACT

A piston crown having a combustion surface and an internal piston surface extending from the combustion surface toward a piston rod. The internal piston surface defines one or more channels extending through the internal piston surface, and at least one of the channels defines a non-linear or curved path between a channel inlet and a channel outlet. Further, at least one of the channels is configured to transfer coolant from the channel inlet to the channel outlet so that thermal energy flowing from the combustion surface as a result of a combustion event may be absorbed by the coolant and subsequently removed from the piston crown.

### BACKGROUND

### Technical Field

The subject matter described herein relates to configurations for a piston crown for an engine.

### Discussion of Art

Combustion systems in internal combustion (IC) engines produce significant thermal energy by mixing various fuels and gases at high temperatures and pressures. Piston crowns are essential components of IC engines, forming the top of the combustion chamber. They contain the high-pressure, high-temperature combustion gases within the cylinder during the combustion process. Because they are in direct contact with these gases, piston crowns must manage thermal energy to prevent deformation or failure.

The shape of the piston crown, including both its external combustion surface and internal cooling surfaces, significantly influences the ignition and combustion of the air/fuel mixture, impacting the efficiency and emissions of the process. However, the piston crown must also endure the harsh conditions of combustion without failing. If the temperature exceeds the material's tolerance, the crown may crack, leading to premature failure. Also, if the thermal load is not uniformly distributed across the crown, that may cause it to crack.

The internal cooling surface of the piston crown often features cooling channels designed to dissipate the thermal energy generated on the external combustion surface. However, these channels can only cool areas where they provide sufficient coolant. Therefore, piston crown designs must balance the integration of enough cooling channels to effectively cool the hottest parts of the combustion surface, while ensuring the crown maintains adequate thickness to preserve structural integrity. Consequently, there is a potential need for innovative piston crown designs and methods that improve upon current options.

### SUMMARY

In various embodiments, the subject matters described herein relate to a piston crown, including a combustion surface and an internal piston surface extending from the combustion surface toward a piston rod. The internal piston surface defines one or more channels extending through the internal piston surface, and at least one of the channels defines an irregular path between a channel inlet and a channel outlet and can transfer coolant from the channel inlet to the channel outlet to absorb thermal energy generated by combustion on the combustion surface by the coolant and subsequently removed from the piston crown.

In various embodiments, the subject matter described herein relates to a piston crown that has a combustion surface defining at least one protrusion extending away from the body of the piston crown. The protrusion may concentrate, or disperse, thermal energy generated during a combustion event. The surface may further be defined by an internal piston surface that is spaced from the combustion surface. The internal piston surface defines at least one channel extending through the body of the piston crown. The at least one channel defines an irregular path between a channel inlet and a channel outlet. The channel can be aligned with the protrusion and may conduct thermal energy generated by the combustion event. It can disperse the energy that may concentrate at the protrusion and transport the energy away. That is, the thermal energy may be directed towards or away from the protrusion depending on the protrusion design, location, etc. relative to the channel.

In various embodiments, the subject matter described herein relates to a method of operating an engine having a piston crown in a cylinder, including injecting a stream of fuel and air into a combustion chamber adjacent to the piston crown; guiding the fuel and air streams via surface features of the piston crown to mix with each other to create a fuel/air mixture and to distribute the fuel/air mixture throughout the combustion chamber; combusting the fuel/air mixture to generate thermal energy; concentrating at least some of the thermal energy at determined locations on a surface of the piston crown; and cooling the determined locations of the piston crown surface having the concentrated thermal energy.

### BRIEF DESCRIPTION OF THE DRAWINGS

The subject matter may be understood from reading the following description of non-limiting embodiments, with reference to the attached drawings, wherein below:

FIG. 1 is a schematic diagram of combustion system in accordance with at least one embodiment of the present disclosure;

FIG. 2 is a perspective view of a piston crown in accordance with at least one embodiment of the present disclosure;

FIG. 3 is a top view of the piston crown of FIG. 2;

FIG. 4 is a bottom view of the piston crown of FIG. 2;

FIG. 5 is a cross-sectional view of the piston crown along section 5-- 5 as shown in FIG. 3; and

FIG. 6 is a logic diagram of a method for operating an engine having a piston crown in accordance with at least one embodiment of the present disclosure.

### DETAILED DESCRIPTION

Piston crowns can be subject to intense thermal energy during combustion, requiring thermal management to reduce or prevent cracking and premature failure. While traditional piston crown designs utilize straight cooling channels that only target limited areas of the crown, they require thick and/or expensive materials to withstand the high pressures and temperatures. In one embodiment, a piston crown features irregular cooling channels that are embedded within or defined by an internal surface of the crown and extend through portions of its body. Coolant flowing through these channels can enhance the cooling of the combustion surface, and, if cooler or more efficient at moving thermal energy, can reduce the need for excess material thickness. By incorporating one or more irregular cooling channels, the piston crown can manage varying thermal loads across the surface and can help to improve performance and reduce weight. Suitable channels can be asymmetrically distributed. The disclosed piston crown can incorporate one or more conformal cooling channels designed to maintain the surface temperature within determined material limits or below certain threshold temperatures.

A suitable piston crown can be manufactured using laser powder bed fusion additive manufacturing. This method allows for precise creation of the cooling channels. The process includes generating a computer-aided design (CAD) model, printing with a metal or ceramic printer, and completing post-processing steps such as stress relief and machining.

In various embodiments, the present disclosure provides a piston crown. The piston crown includes a combustion surface and an internal piston surface extending from the combustion surface toward a piston rod. The internal piston surface defines one or more channels extending through the internal piston surface, and at least one of the channels defines an irregular (e.g., non-linear or curved) path between a channel inlet and a channel outlet. The at least one channel transfers coolant from the channel inlet to the channel outlet to absorb thermal energy generated by combustion on the combustion surface by the coolant and subsequently removed from the piston crown. Suitable coolant may include water, oil, and other thermal transport fluids and may be selected with reference to the end use parameters. Water, for example, may include additives that reduce corrosion, reduce localized steam bubbles, and the like.

In various embodiments, the one or more channels of the piston crown may include two or more channels that are asymmetrically distributed relative to each other within the piston crown as defined by the internal piston surface. In various embodiments of the piston crown, the asymmetric distribution of the two or more channels may result in varying thermal rejection in the piston crown based at least in part on varying heat generation during combustion at different locations within a cylinder operatively coupled to the piston crown.

In various embodiments, the at least one channel of the piston crown is one of a plurality of channels. The plurality of channels may include a first subset of channels and a second subset of channels. The first subset of channels cools the combustion surface at a first location differently than the second subset of channels at a second location. In various embodiments of the piston crown, the first subset of channels defines a first channel volume that is greater than a second channel volume defined by the second subset of channels, to transfer a greater amount of coolant through the first subset of channels compared to the second subset of channels.

In various embodiments, the internal piston surface of the piston crown has a thickness of material or a distance from the combustion surface that is selected based at least in part on the thermal conductivity for heat absorption and transfer via the cooling channels. Other factors may include the coolant type, the flow rate, the channel diameter, the surface profile of the inner surface, the degree of curvature, the temperature of the incoming coolant, the distance of the channel to the combustion surface, the thermal conductivity of the piston material, and the like.

In various embodiments, the internal piston surface of the piston crown defining the channel has a cross-sectional profile that varies along its length, being one of larger diameter, smaller diameter, more circular, or more ovoid. In one embodiment, the channel is one of a plurality of channels, and at least one of the channels has a different cross-sectional profile diameter relative to the other. Accordingly, all things being equal, the flow rate through one channel differs relative to the potential flow rate of coolant through the other. A suitable manufacturing method for channel creation may include drilling, casting, and additive manufacturing methods.

In various embodiments, the present disclosure provides a piston crown. The piston crown includes a combustion surface defining at least one protrusion (e.g., projection or protuberance) extending away from the body of the piston crown to concentrate thermal energy generated during a combustion event and an internal piston surface spaced from the combustion surface. The internal piston surface defines at least one channel extending through the body of the piston crown. The at least one channel defines an irregular (e.g., non-linear or curved) path between a channel inlet and a channel outlet. The at least one channel is aligned with the protrusion to conduct thermal energy generated by the combustion event and concentrated at the protrusion away from the protrusion.

In various embodiments, the at least one channel of the piston crown includes two or more channels that are asymmetrically distributed relative to each other within the piston crown as defined by the internal piston surface. In various embodiments of the piston crown, the asymmetric distribution of the two or more channels results in varying thermal rejection in the piston crown based at least in part on varying heat generation during combustion at different locations in a cylinder operatively coupled to the piston crown.

In various embodiments, the at least one channel of the piston crown is one of a plurality of channels. The plurality of channels includes a first subset of channels and a second subset of channels. The protrusion is one of a plurality of protrusions. The first subset of channels cools the first subset of protrusions.

In various embodiments, the at least one protrusion of the piston crown has a convex portion. In various embodiments, the at least one protrusion of the piston crown has an elongate ridge portion.

In various embodiments, the combustion surface of the piston crown defines a portion of a combustion chamber. The piston crown is operably engaged with an engine cylinder that defines another portion of the combustion chamber. The combustion chamber receives an asymmetrical injection of fuel during operation, resulting in an uneven thermal load on the combustion surface. The protrusion of the piston crown may facilitate fuel distribution in the combustion chamber prior to combustion or the protrusion of the piston crown may facilitate heat removal from the combustion chamber via unequal heat extraction to concentrate the thermal energy at the protrusion and circulate cooling fluid through the channels disproportionately to the protrusion.

In various embodiments, the channel of the piston crown has a cross-sectional profile that changes along its length. The channel is narrower in some portions and wider in other portions. Similarly, along its length, the rate of curvature may change and the surface finish of the inner surface may change.

In various embodiments, the present disclosure provides a method of operating an engine having a piston crown in a cylinder. The method includes injecting a stream of fuel and air into a combustion chamber adjacent to the piston crown; guiding the fuel and air streams via surface features of the piston crown to mix with each other to create a fuel/air mixture and to distribute the fuel/air mixture throughout the combustion chamber; combusting the fuel/air mixture to generate thermal energy; concentrating at least some of the thermal energy at determined locations on a surface of the piston crown; and cooling the determined locations of the piston crown surface having the concentrated thermal energy.

In various embodiments, the piston crown combustion surface may be cooled disproportionately. In various embodiments, the method includes cooling determined locations of the piston crown surface. This may be accomplished by selectively flowing or transferring coolant through one or more cooling channels defined on an internal piston surface, where at least one of the channels defines an irregular path between a channel inlet and a channel outlet. The concentrated thermal energy may be absorbed from the determined locations of the piston crown surface by the coolant; which may then be flowed out from the piston crown. In various embodiments, the stream of fuel may be injected as a plurality of different fuel streams and in some cases those fuel streams may have fuel types that differ from each other. In one case a fuel stream injection may be at an angle that is skewed relative to another fuel stream.

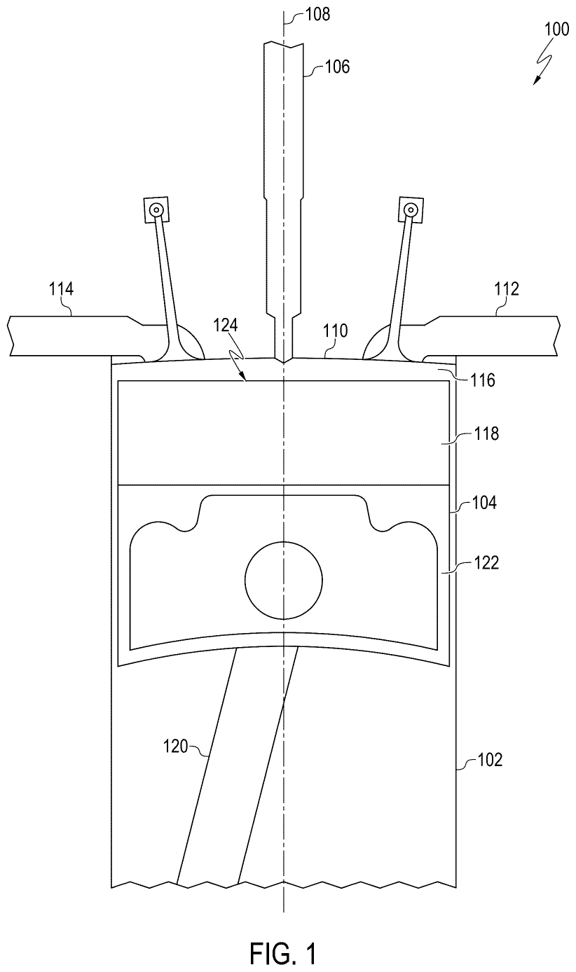

Referring now to the figures, FIG. 1 is a schematic diagram of a combustion system 100 for an engine, for example, an internal combustion engine, in accordance with one embodiment of the present disclosure. The combustion system can include a cylinder 102, a piston 104, and a fuel injector 106. In some embodiments, the combustion system may include a plurality of cylinders and other corresponding components, such as a plurality of pistons and a plurality of fuel injectors, and the like.

The cylinder may be a body of metal having at least one cylindrical aperture formed therein for receiving the piston. The cylinder can define a central axis 108 and include a cylinder head 110 positioned at the top of the cylinder with respect to the central axis of the cylinder. The cylinder can receive intake air from an intake passage 112 and release combustion gases to an exhaust passage 114.

As illustrated in FIG. 1, the fuel injector may be a single fuel injector. In various embodiments, the fuel injector may be a multi-fuel injector, which may spray/inject multiple fuels, such as, for example, direct-injection of both natural gas and diesel into the cylinder. The fuel injector may be coupled to the cylinder and may inject fuel (e.g., diesel) directly thereinto. The fuel injector may include a fuel nozzle which extends directly into a central portion of a combustion chamber 116 of the cylinder. The fuel nozzle can include at least one hole for injecting fuel into the cylinder and/or toward a particular location on the piston crown 118. In some embodiments, the fuel injector may include multiple holes at an end of the fuel nozzle.

In the illustrated embodiment, the fuel injector is positioned axially, with respect to the central axis of the cylinder. In certain other embodiments, the fuel injector may be inclined or skewed with respect to the central axis of the cylinder, such that fuel is injected offset from the central axis, depending on design requirements. The offset fuel injection may facilitate direct-injection of a second fuel into the cylinder. Suitable second fuels may include natural gas, hydrogen, ammonia, dimethyl ether, alcohol (e.g., ethanol), and gasoline. In one embodiment, a suitable fuel may be a liquid fuel that is able to be combusted in the internal combustion engine through compression ignition. In other embodiments, a suitable fuel may be natural gas, gasoline, hydrogen, alcohol, kerosene, biodiesel, or other petroleum distillates of similar density, that may be combusted in the internal combustion engine through spark ignition. Where a spark ignition is used, an amount of diesel may be unnecessary or optional as the ignition source. Where a second fuel that is not amenable to compression ignition is used, and no spark ignition is available, the primary fuel (that is, the fuel from the main injector along the central axis, may be a compression ignition source (such as diesel).

In further reference to FIG. 1, the piston may be positioned within the cylinder and centered along the central axis. The piston may move vertically within the cylinder with respect to the central axis of the cylinder. Further, the piston may be coupled to a crankshaft via a piston rod 120 so that the reciprocating motion of the piston is translated into the rotational motion of the crankshaft through the piston rod.

The piston can include a piston crown and a piston skirt 122. The piston crown and the piston skirt may be two separate components coupled to each other to form the piston. Alternatively, the piston crown and the piston skirt may be integral components formed as one-piece, for example, as a unitary piston.

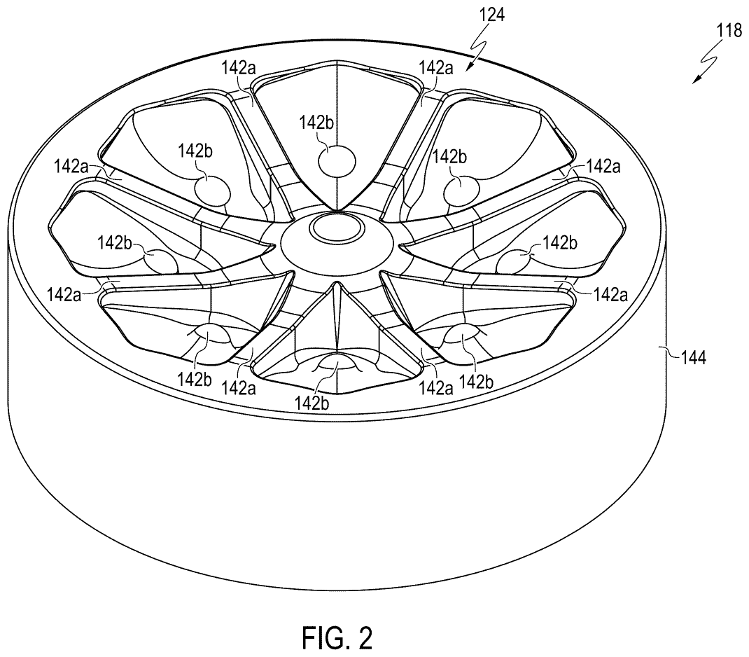

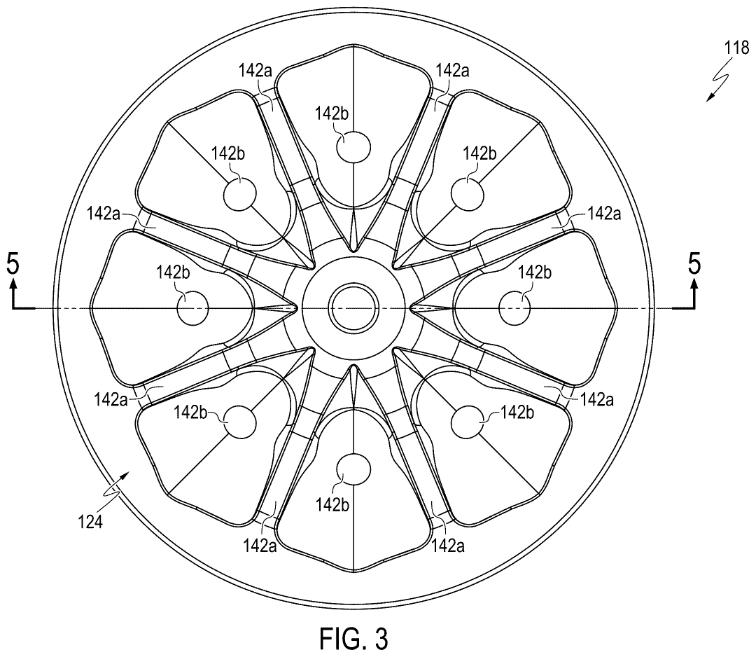

FIG. 2 is a perspective view of a piston crown in accordance with at least one embodiment of the present disclosure and FIG. 3 is a top view of the piston crown of FIG. 2. As shown in FIGS. 2 and 3, the piston crown includes a combustion surface 124. The combustion surface may have various shapes/designs for controlling combustion of the fuel. For example, the shape/design of the combustion surface may constrain the combustion of the fuel at an initial stage of fuel spray development so as to reduce NOₓ and rapidly combust the fuel and oxidize soot (e.g., particulate matter generated during the initial stage) at a later stage. Thus, the combustion surface design may reduce the emissions (e.g., particulate matter and NOₓ) and specific fuel consumption. Additionally, the combustion surface shape and design may concentrate the thermal energy generated during the combustion event, this may be a result of the fuel distribution in the combustion chamber prior to combustion, for example. U neven heat creation may be addressed by heat removal from the piston crown (through the combustion surface) via unequal heat extraction. With more thermal energy being removed from those areas that receive more thermal energy input.

Referring again to FIG. 1, in one or more embodiments, the combustion chamber can be formed between the combustion surface, piston crown, sides of the cylinder, and the cylinder head. During operation of the combustion system, the piston can cycle between the bottom of the cylinder, which increases the volume of the combustion chamber, and proximate to the cylinder head, which compresses the air within the combustion chamber. As the piston is at the top of its stroke and closest to the cylinder head, such that the combustion chamber is at its smallest volume, the fuel injector can inject fuel into the combustion chamber. This can cause the combustion of the fuel and air, resulting in the production of combustion gases, which can push the piston back to the bottom of the piston stroke. The linear movement of the piston through this cycle can be converted to rotation torque of the rotary shaft via the crankshaft.

The production of combustion gases in the combustion chamber during the combustion cycle, which drives the piston by the force of the expanding gases, can be referred to as a combustion event. The combustion event can generate a significant amount of thermal energy within the combustion chamber and on the combustion surface of the piston crown.

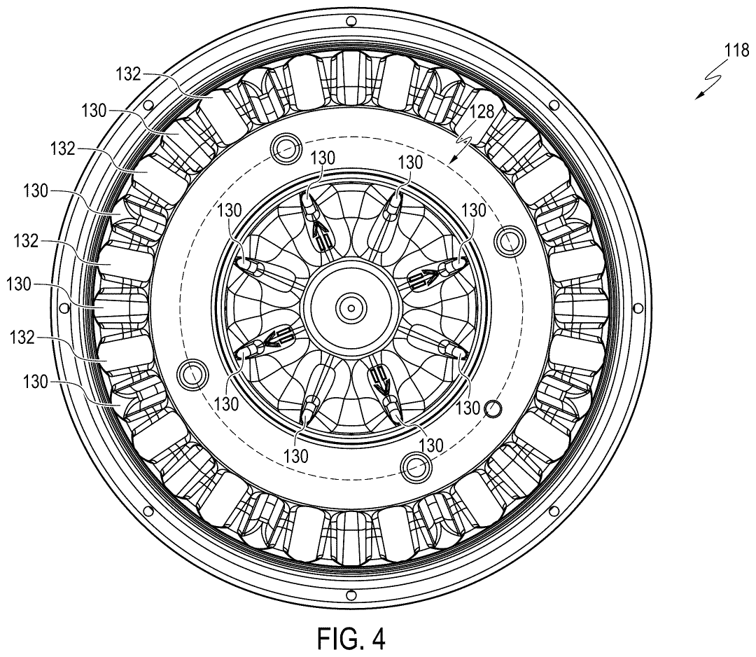

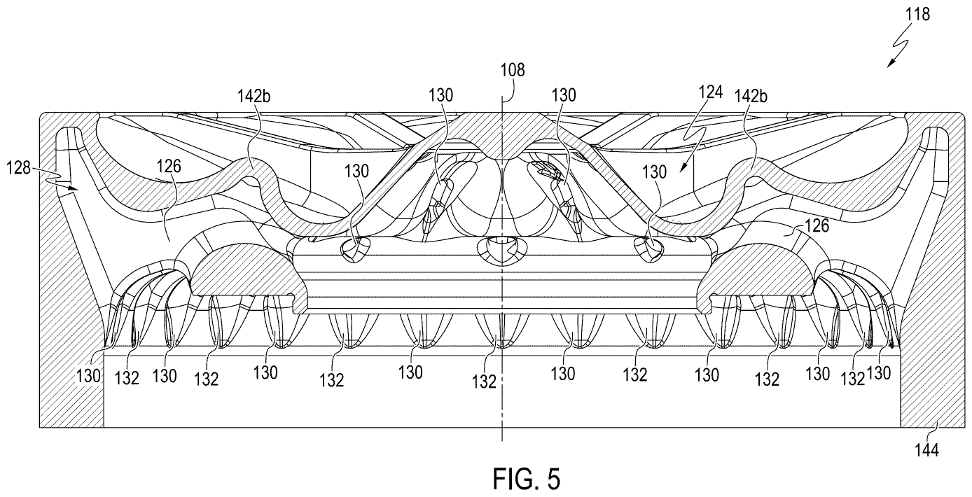

The thermal energy generated by the combustion event can be removed from the combustion surface of the piston crown using coolant transmitted through channels 126 defined by and extending through an internal piston surface 128 of the piston crown. FIG. 4 is a bottom view of the piston crown of FIG. 2 and FIG. 5 is a cross-sectional view of the piston crown along section 5-5 as shown in FIG. 3. FIGS. 4 and 5 illustrate an internal piston surface in accordance with the present disclosure. At least one of the channels can transfer coolant from the channel inlet 130 to the channel outlet 132 so that the thermal energy flowing from the combustion surface as a result of the combustion event is absorbed by the coolant and subsequently removed from the piston crown. Incorporating channels on the internal piston surface can enable the dissipation of the thermal energy generated on the external combustion surface of the piston crown to prevent the piston crown from cracking, resulting in premature failure of the crown.

The internal piston surface extends from the combustion surface toward the piston rod. In various embodiments, the internal piston surface can define a determined thickness of metal or a distance across a portion of the piston crown to the combustion surface. The internal piston surface can have a cross-sectional profile that differs along its length. For example, the cross-sectional profile of the internal piston surface may have larger or smaller diameter along the length of the piston crown. As another example, the cross-sectional profile of the internal piston surface may be more circular or more ovoid at different locations across the length of the piston crown. In one embodiment, the cross-sectional profile of the internal piston surface may be arbitrarily shaped to optimize the combination of packaging, channel area, and/or heat transfer.

The internal piston surface can define one or more channels extending through the internal piston surface. At least one of the channels can define a non-linear or curved path between the channel inlet to the channel outlet. In various embodiments, more than one or all of the channels define non-linear or curved paths. Linearity of the channels can be measured in two-dimensions and/or in three-dimensions. Furthermore, the non-linear or curved path of the channel may be curved in more than one plane.

In further reference to FIGS. 4 and 5, there can be a plurality of channels defined by the internal piston surface. The present disclosure contemplates any number of channels. For example, the piston crown shown in FIG. 4 includes at least 40 channels. However, additional or fewer channels may be included based on the required cooling for the particular piston crown/piston/cylinder/engine. For example, a piston crown in accordance with the present disclosure may have 4 channels. Other suitable numbers of channels may be selected with reference to end use parameters-the bore size of the engine, the type of fuel, the duty cycle of the engine, the geometry and orientation of the fuel injector(s), the material used, and so on.

Each channel may include its own channel inlet and its own channel outlet. In various other aspects of the present disclosure, some channels may have common channel inlets and/or common channel outlets. For example, adjacent channels may have the same channel inlet, but the path of the channel may split within the internal piston surface, resulting in two or more channel outlets.

The topography of the combustion surface can also influence the quantity, positioning, and design of the channels extending through the internal piston surface. In one embodiment, the combustion surface may include an outer wall and a concave recessed inner portion, similar to a bowl. During the combustion event, the air/fuel mixture combusts within the bowl-shaped combustion surface. This may create heat concentrations on the combustion surface around the radii and/or the outer edges of the wall of the recessed inner portion due to the proximity of these features to the combustion gases, the flame front, and so on.

However, the topography of the combustion surface can be modified to concentrate the thermal energy generated during the combustion process at different portions of the combustion surface. For example, as shown in FIGS. 2 and 3, the combustion surface of the piston crown can include protrusions 142 (e.g., projections or protuberances), such as spines/ridges 142a and/or dimples 142b, which extend away from the body 144 of the piston crown toward the combustion chamber. The protrusions can concentrate or focus a disproportionate amount of thermal energy to create intentional hot spots in a determined location, such as opposed to the radii and/or the outer walls of the piston crown. The protrusions can facilitate fuel distribution in the combustion chamber prior to combustion and facilitate heat removal from the combustion chamber via unequal heat extraction.

The distribution of thermal energy across the combustion surface of the piston crown may also be impacted by how fuel is injected into the combustion chamber. For example, fuel may be asymmetrically injected into the combustion chamber, which can result in a corresponding uneven thermal load on the combustion surface.

Cooling channels, particularly irregular, e.g., non-linear, cooling channels, can be added on the internal piston surface of the piston crown to remove the concentrated pockets of high thermal energy and/or uneven thermal load distributions created by the protrusions (e.g., projections or protuberances) on the combustion surface. Traditional manufacturing techniques previously limited cooling channels to regular or linear forms to prevent the cooling of topographical structures such as protrusions on the combustion surface. Specifically, the traditional linear cooling channels of piston crowns were only able to transfer coolant to the outer edge of the piston crown. However, using additive manufacturing techniques, cooling channels can now include irregular non-linear paths to allow coolant to reach the protrusions to remove the concentrated thermal energy from the combustion surface. If the cooling channels were otherwise unable to reach these structures, the piston could overheat and fail by cracking due to excess stress within the material.

The channels can extend across the internal piston surface in any manner necessary to enable coolant traveling therethrough to reach the concentrated pockets of high thermal energy created by the topography of the combustion surface. For example, the channels can be distributed symmetrically or asymmetrically about the central axis of the piston crown. In various embodiments, wherein the internal piston surface defines two or more channels, such channels can be asymmetrically distributed relative to each other within the piston crown as defined by the internal piston surface. The asymmetric distribution of the two or more channels can provide differing amounts of thermal rejection in the piston crown. The manner in which the channels are asymmetrically distributed within the piston crown can be based at least in part on different degrees of heat generation from the combustion event at different locations in the cylinder.

The channels also may vary in size to address different cooling needs across the piston crown. For example, at least one of the channels defined in the internal piston surface may have a cross-sectional profile that changes along its length so as to be narrower in some portions and wider in other portions. As another example, the internal piston surface may define a plurality of channels. The plurality of channels may include a first subset of channels 126a to cool the combustion surface differently in one location in contrast to a second subset of channels 126b that provide thermal management at least somewhat independently in a second location. The first subset of channels may define a first channel volume that is greater than a second channel volume defined by the second subset of channels, such that a larger amount of coolant is transferrable through the first subset of channels than the second subset of channels based on the first channel volume and the second channel volume. As another example, the first subset of channels may achieve a first flow rate of coolant being transferred therethrough and the second subset of channels may achieve a second flow rate of coolant being transferred therethrough. The first flow rate may be different from the second flow rate, and the first and second flow rates may be dependent on the amount of thermal energy being removed from the portion of the piston crown cooled by each subset of channels.

As mentioned above, the combustion surface may define at least one projection or protuberance that extends away from the piston crown and may concentrate thermal energy generated during the combustion event. The protrusions (e.g., projections or protuberances) may take any size, shape, or form sufficient to concentrate the thermal energy generated during the combustion event. For example, the protrusion may have a portion that is substantially convex. As another example, the protrusion may have a portion that is an elongate ridge or a spine. As another example, the protrusion may include a dimple. At least one channel defined on the internal piston surface may be aligned with the protrusion to conduct the thermal energy generated by the combustion event and concentrated at the protrusion away from the protrusion.

In various embodiments, the size or shape of the channel may be varied to remove the thermal energy concentrated across different types of protrusions (e.g., projections or protuberances) on the combustion surface. For example, the combustion surface may define a plurality of protrusions, including a first subset of protrusions and a second subset of protrusions. The first subset of protrusions may be the same as the second subset of protrusions. Alternatively, the first subset of protrusions may be different from the second subset of protrusions. The internal piston surface may define a plurality of channels. The plurality of channels can include a first subset of channels to cool the first subset of protrusions. The plurality of channels can also include a second subset of channels. The second subset of channels cool the second subset of protrusions.

As shown in FIGS. 2-5, for example, the piston crown may include a combustion surface including a plurality of protrusions. A first subset of the plurality of protrusions (e.g., projections or protuberances) may include the plurality of dimples defined on the combustion surface. The second subset of the plurality of protrusions may include the plurality of spines/ridges defined on the combustion surface. The internal piston surface may define a plurality of channels. A first subset of the plurality channels may be defined near the center of the internal piston surface and have a first channel volume. A second subset of the plurality of channels may extend near the outer diameter of the internal piston surface of the piston crown and have a second channel volume. The first channel volume may be greater than the second channel volume. Each of the channels of the plurality of channels may include a respective channel inlet and a respective channel outlet. The first subset of the plurality of channels may include a path aligned with the first subset of protrusions (e.g., the plurality of dimples), such that coolant can be transferred from the center of the internal piston surface through the first subset of the plurality of channels to remove the thermal energy concentrated on the plurality of dimples on the combustion surface. The second subset of the plurality of channels may include a path aligned with the second subset of protrusions (e.g., the plurality of spines/ridges), such that the coolant can be transferred from the outer diameter of the internal piston surface through the second subset of the plurality of channels to remove the thermal energy concentrated on the plurality of spines/ridges on the combustion surface. The dimples on the combustion surface may concentrate a larger amount of thermal energy than the spines/ridges, so the volume of the channels aligned with the dimples may be greater than the volume of the channels aligned with the spines/ridges. It should be noted herein that the above description merely is an example and should not be construed as a limitation of the present disclosure.

By incorporating the non-linear channels to facilitate improved cooling of the combustion surface, the overall material thickness of the piston crown may be reduced. In one embodiment, the thickness may be about constant across the outer surface of the piston crown. Additional material may no longer necessary to strengthen the piston crown in response to high thermal load thereon. This can result in material cost savings and reduced maintenance of piston crowns. A lighter piston may aid in reducing energy consumption and may improve lifetime and reliability of other components.

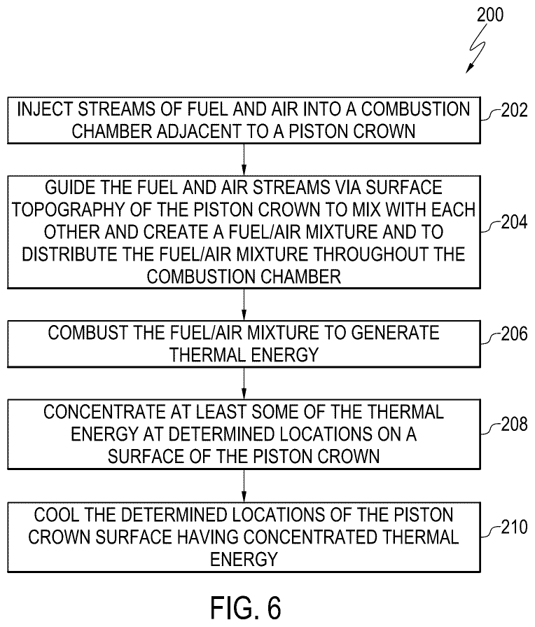

FIG. 6 is a method 200 of operating an engine having a piston crown in a cylinder. The method may involve an engine that uses a piston crown as described herein. The method may include injecting 202 streams of fuel and air into a combustion chamber adjacent to the piston crown. The method can further include guiding 204 the fuel and air streams via the surface topography of the piston crown to mix with each other in order to create a fuel/air mixture and to distribute the fuel/air mixture throughout the combustion chamber. The method can further include combusting 206 the fuel/air mixture to generate thermal energy. The method can further include concentrating 208 at least some of the thermal energy at determined locations on a surface of the piston crown. The method can further include cooling 210 the determined locations of the piston crown surface having the concentrated thermal energy. In various embodiments, the combustion surface of the piston crown may have uneven thermal load. As a result, the piston crown surface may be cooled disproportionately but responsively to the uneven thermal energy concentration.

Cooling the determined locations of the piston crown surface in accordance with the method described herein may include transferring coolant through one or more cooling channels defined on the internal piston surface. As described in detail herein, at least one of the channels may define a non-linear or curved path between a channel inlet and a channel outlet. Cooling the determined locations may further include absorbing, by the coolant, the concentrated thermal energy from the determined locations of the piston crown surface; and removing the coolant from the piston crown.

Injecting the stream of fuel in accordance with the method described herein may include injecting a plurality of fuel streams. At least one of the fuel streams may be injected skewed relative to the other fuel stream(s).

While one or more embodiments are described in connection with a rail vehicle system, not all embodiments are for rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

Examples of the devices and methods disclosed herein, according to various aspects of the present disclosure, are provided below in the following embodiments. An embodiment or aspect of the devices and methods may include any one or more than one of, and any combination of, the embodiments or aspects described.

One general embodiment includes a piston crown. The piston crown has a combustion surface. The crown includes an internal piston surface extending from the combustion surface toward a surface that is adjacent to a piston rod. The internal piston surface defines one or more channels extending through the internal piston surface, and at least one of the channels defines an irregular path between a channel inlet and a channel outlet, where the at least one channel may transfer coolant from the channel inlet to the channel outlet to absorb thermal energy generated by combustion on the combustion surface by the coolant and subsequently removed from the piston crown.

Implementations may include one or more of the following features. The piston crown where the one or more channels may include two or more channels that are asymmetrically distributed relative to each other within the piston crown as defined by the internal piston surface. The asymmetric distribution of the two or more channels results in varying thermal rejection in the piston crown based at least in part on varying heat generation during combustion at different locations within a cylinder operatively coupled to the piston crown. The at least one channel is one of a plurality of channels, the plurality of channels may include a first subset of channels and a second subset of channels, and where the first subset of channels may cool the combustion surface at a first location differently than the second subset of channels at a second location. The first subset of channels defines a first channel volume greater than a second channel volume defined by the second subset of channels, to transfer a greater amount of coolant through the first subset of channels compared to the second subset of channels. The internal piston surface defines a thickness of material or a distance from the combustion surface to optimize the thermal conductivity for heat absorption and transfer via the cooling channels. The internal piston surface defining the channel has a cross-sectional profile that varies along its length, being one of larger diameter, smaller diameter, more circular, or more ovoid. Implementations of the described techniques may include hardware, a method or process, or computer software on a computer-accessible medium.

One general embodiment includes a piston crown. The piston crown may have a combustion surface defining at least one protrusion extending away from the body of the piston crown, and that may concentrate thermal energy generated during a combustion event. The crown may have an internal piston surface spaced from the combustion surface, with the internal piston surface defining at least one channel extending through the body of the piston crown. The channel may define an irregular path between a channel inlet and a channel outlet, and where the channel may align with the protrusion and may conduct thermal energy (that is generated by the combustion event and then is concentrated at the protrusion) away from the protrusion.

Implementations may include one or more of the following features. The piston crown where the at least one channel may include two or more channels that are asymmetrically distributed relative to each other within the piston crown as defined by the internal piston surface. The asymmetric distribution of the two or more channels results in varying thermal rejection in the piston crown based at least in part on varying heat generation during combustion at different locations in a cylinder operatively coupled to the piston crown. The at least one channel is one of a plurality of channels, and the plurality of channels may include a first subset of channels and a second subset of channels, the protrusion being one of a plurality of protrusions, and the first subset of channels may cool the first subset of protrusions. The at least one protrusion has a convex portion. The at least one protrusion has an elongate ridge portion. The combustion surface defines a portion of a combustion chamber, and the piston crown may be operably engaged with an engine cylinder that defines another portion of the combustion chamber. The combustion chamber may receive an asymmetrical injection of fuel during operation, resulting in an uneven thermal load on the combustion surface. The protrusion may facilitate fuel distribution in the combustion chamber prior to combustion or facilitate heat removal from the combustion chamber via unequal heat extraction to concentrate thermal energy at the protrusion and circulate cooling fluid through the channels disproportionately to the protrusion. The channel has a cross-sectional profile that changes along its length, whereon the channel is narrower in some portions and wider in other portions.

One general embodiment includes a method of operating an engine having a piston crown in a cylinder. The method also includes injecting a stream of fuel and air into a combustion chamber adjacent to the piston crown. The method also includes guiding the fuel and air streams via surface features of the piston crown to mix with each other to create a fuel/air mixture and to distribute the fuel/air mixture throughout the combustion chamber. The method also includes combusting the fuel/air mixture to generate thermal energy. The method also includes concentrating at least some of the thermal energy at determined locations on a surface of the piston crown. The method also includes cooling the determined locations of the piston crown surface having the concentrated thermal energy.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

1. A piston crown, comprising a body having:
a combustion surface; and
an internal piston surface extending from the combustion surface toward a piston rod, wherein the internal piston surface defines one or more channels extending through the internal piston surface, and at least one of the channels has its own channel inlet and its own channel outlet and defines an irregular path between the channel inlet and the channel outlet, and the at least one channel is configured to transfer coolant from the channel inlet to the channel outlet to absorb thermal energy generated by combustion on the combustion surface by the coolant and subsequently removed from the piston crown.

2. The piston crown of claim 1, wherein the one or more channels comprise two or more channels that are asymmetrically distributed relative to each other within the piston crown as defined by the internal piston surface.

3. The piston crown of claim 2, wherein the asymmetric distribution of the two or more channels results in varying thermal rejection in the piston crown based at least in part on varying heat generation during combustion at different locations within a cylinder operatively coupled to the piston crown.

4. The piston crown of claim 1, wherein the at least one channel is one of a plurality of channels, the plurality of channels comprising a first subset of channels and a second subset of channels, and wherein the first subset of channels is configured to cool the combustion surface at a first location differently than the second subset of channels at a second location.

5. The piston crown of claim 4, wherein the first subset of channels defines a first channel volume greater than a second channel volume defined by the second subset of channels, to transfer a greater amount of coolant through the first subset of channels compared to the second subset of channels.

6. The piston crown of claim 1, wherein the internal piston surface defines a thickness of material or a distance from the combustion surface to optimize the thermal conductivity for heat absorption and transfer via the cooling channels.

7. The piston crown of claim 1, wherein the internal piston surface defining the channel has a cross-sectional profile that varies along its length, being one of larger diameter, smaller diameter, more circular, more ovoid, or shaped to optimize packaging, channel area, or heat transfer.

8. A piston crown, comprising a body having:
a combustion surface defining at least one protrusion extending away from the body of the piston crown, configured to concentrate thermal energy generated during a combustion event; and
an internal piston surface spaced from the combustion surface, the internal piston surface defining at least one channel extending through the body of the piston crown, wherein the at least one channel defines an irregular path between a channel inlet and a channel outlet, and wherein the at least one channel is aligned with the protrusion and configured to conduct thermal energy generated by the combustion event and concentrated at the protrusion away from the protrusion.

9. The piston crown of claim 8, wherein the at least one channel comprises two or more channels that are asymmetrically distributed relative to each other within the piston crown as defined by the internal piston surface.

10. The piston crown of claim 9, wherein the asymmetric distribution of the two or more channels results in varying thermal rejection in the piston crown based at least in part on varying heat generation during combustion at different locations in a cylinder operatively coupled to the piston crown.

11. The piston crown of claim 8, wherein the at least one channel is one of a plurality of channels, and the plurality of channels comprises a first subset of channels and a second subset of channels, the protrusion being one of a plurality of protrusions, and the first subset of channels is configured to cool the first subset of protrusions.

12. The piston crown of claim 8, wherein the at least one protrusion has a convex portion.

13. The piston crown of claim 8, wherein the at least one protrusion has an elongate ridge portion.

14. The piston crown of claim 8, wherein the combustion surface defines a portion of a combustion chamber, and the piston crown is configured to be operably engaged with an engine cylinder that defines another portion of the combustion chamber, wherein the combustion chamber is configured to receive an asymmetrical injection of fuel during operation, resulting in an uneven thermal load on the combustion surface.

15. The piston crown of claim 14, wherein the protrusion is configured to facilitate fuel distribution in the combustion chamber prior to combustion or facilitate heat removal from the combustion chamber via unequal heat extraction to concentrate thermal energy at the protrusion and circulate cooling fluid through the channels disproportionately to the protrusion.

16. The piston crown of claim 8, wherein the channel has a cross-sectional profile that changes along its length, whereon the channel is narrower in some portions and wider in other portions.

17. A method of operating an engine having a piston crown in a cylinder, comprising:
injecting a stream of fuel and a stream of air into a combustion chamber adjacent to the piston crown;
guiding the fuel and air streams via surface features of the piston crown to mix with each other to create a fuel/air mixture and to distribute the fuel/air mixture throughout the combustion chamber;
combusting the fuel/air mixture to generate thermal energy;
concentrating at least some of the thermal energy at determined locations on a surface of the piston crown; and
cooling the determined locations of the piston crown surface having the concentrated thermal energy.

18. The method of claim 17, wherein the piston crown surface is cooled disproportionately.

19. The method of claim 18, wherein cooling the determined locations of the piston crown surface comprises:
transferring coolant through one or more cooling channels defined on an internal piston surface, wherein at least one of the channels defines an irregular path between a channel inlet and a channel outlet;
absorbing the concentrated thermal energy from the determined locations of the piston crown surface by the coolant; and
removing the coolant from the piston crown.

20. The method of claim 17, wherein injecting the stream of fuel comprises injecting a plurality of fuel streams; and injecting at least one fuel stream skewed relative to the other fuel stream.
